(19) United States
(12) Patent Application Publication
(10) Pub. No.: US 2003/0144859 A1
(43) Pub. Date: Jul. 31, 2003

(54) E-service publication and discovery method and system

(76) Inventors: Meichun Hsu, Los Altos Hills, CA (US); Bin Zhang, Fremont, CA (US)

Correspondence Address: HEWLETT-PACKARD COMPANY, Intellectual Property Administration, P.O. Box 272400, Fort Collins, CO, 80527-2400, US

(21) Appl. No.: 10/066,097

(22) Filed: Jan. 31, 2002

(51) Int. Cl. G06F 17/60

(52) U.S. Cl. 705/1

(57) ABSTRACT

Service publication and discovery method and system. The system includes a client organization, a discovery agent, a client agent, and one or more service provider organizations that provide e-services. First, the service provider organizations that provide e-services publish at least one e-service description in a predetermined format. Second, the client organization employs a discovery agent to find prospective e-services based on one or more search parameters. Third, the discovery agent provides prospective services that satisfy the search parameters. Then, the client organization utilizes the client agent to programmatically connect to the service provider services by employing a protocol that is compatible with the e-service provider.

### FIELD OF THE INVENTION

The present invention relates generally to electronic business technology, and more particularly, to an e-service publication and discovery method and system.

### BACKGROUND OF THE INVENTION

With the explosive growth of business to business (B2B) electronic commerce or eCommerce, the Internet presents incredible opportunities for businesses of all sizes. For example, business to business (B2B) eCommerce provides opportunities to find new customers, to streamline supply chains, to provide new services, and to pursue financial gain.

Organizations that have moved their business online are already realizing significant economic and competitive gains, such as increased revenue, lowered costs, new customers, branding opportunities, and the creation of new forms of customer service.

Despite the outstanding growth of B2B eCommerce in the last few years, there exists a major impediment to opening up worldwide trade to those already conducting B2B eCommerce and to the businesses that are not yet players in the digital economy.

This impediment can be described as follows. Most eCommerce-enabling applications and Web services currently in place employ divergent paths to connect buyers, suppliers, marketplaces, and service providers. Without large investments in technology infrastructure, a semiconductor manufacturer in Taiwan, a furniture manufacturer in Pennsylvania, and a specialized industrial engineering firm in New Delhi can transact Internet-based business only with the global trading partners they have discovered and, of those, only the ones using the same applications and Web services. As can be appreciated, this current model is restrictive and limiting.

A growing area of eCommerce is the provision of electronic services. Electronic services (commonly referred to as “E-services”) are commercial services delivered through the Internet. A first example of an Internet-based electronic service is Amazon.com. Amazon.com is an e-service company that sells books and many other products. The customers of Amazon.com are the consumers of the books and products.

A second example of an Internet-based e-service is BizBuyer. BizBuyer sells office supplies, computers, and other equipment that is targeted for business buyers. A third example of an Internet-based e-service is MarketScience. MarketScience is a marketplace solution provider that offers management consulting, technology development, and enterprise integration services. As can be appreciated, there are many different types of e-services and an increasing number of e-service providers. With the growth of the Internet and the increasing appearance of Internet storefronts, there is also an ever-increasing number of e-services and variety of e-services.

As can be appreciated, these services are only of value, if a client or customer is not aware that the services exist. In this regard, it is important for there to be a mechanism through which a client can discover the specific services that are available.

Prior art approaches for performing the discovery of services use registries. As described in greater detail hereinafter, these approaches have significant disadvantages and shortcomings.

Registries

A group of technology and business leaders have come together to develop the Universal Description, Discovery and Integration (UDDI) specification. The UDDI specification is an example that uses registries of services.

The UDDI specification envisions information registries of Web services. These UDDI registries are used to promote and discover Web services. UDDI is also a publicly accessible set of implementations of the specification that allow businesses to register information regarding Web services they offer so that other businesses can find them.

Further information regarding the UDDI specification may be found in a publication entitled, “Universal Description, Discovery and Integration (UDDI) Executive White Paper,” uddi.org, Sep. 6, 2000, a publication entitled, “Universal Description, Discovery and Integration (UDDI) Technical White Paper,” uddi.org, Sep. 6, 2000, and at http://www.uddi.org/.

The BizTalk interoperability framework (BIZTALK) is another example that uses centralized registries of services. Further information about BIZTALK may be found at http:/www.biztalk.org/.

Unfortunately, this approach has several drawbacks. First, the provider of the service must register with the centralized registries before its services can be made available to clients. This registration may involve a fee collected by the registry and involve a burden on the provider of e-services. Second, the exposure of the service to customers may be limited.

Other registration methods involve technologies that are not very pervasive, thereby limiting the exposure of a service. Accordingly, it is desirable for there to be a mechanism for pervasive publishing of e-services.

Furthermore, it is desirable for there to be a mechanism that facilitates the connection between clients that use services and the producers of those services without registration.

Based on the foregoing, there remains a need for an e-service publication and discovery method and system that overcomes the disadvantages set forth previously.

### SUMMARY OF THE INVENTION

According to one embodiment of the present invention, a method and system for publishing and discovering services (e.g., e-services) is described.

One aspect of the present invention is the provision of a mechanism for allowing a service provider to publish services in an autonomous, pervasive, and distributed manner.

Another aspect of the present invention is the provision of a mechanism to enable a client to efficiently discover published services.

According to one embodiment, an e-service publication and discovery method and system is provided. Service publication and discovery method and system. The system includes a client organization, a discovery agent, a client agent, and one or more service provider organizations that provide e-services. First, the service provider organizations that provide e-services publish at least one e-service description in a predetermined format. Second, the client organization employs a discovery agent to find prospective e-services based on one or more search parameters. Third, the discovery agent provides prospective services that satisfy the search parameters. Then, the client organization utilizes the client agent to programmatically connect to the service provider services by employing a protocol (e.g., a predetermined communication and invocation protocol) that is compatible with the e-service provider.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a system according to one embodiment of the present invention in which the publication and discovery mechanisms of the present invention can be implemented.

FIG. 2 is a block diagram illustrating in greater detail the discovery agent of FIG. 1 according to one embodiment of the present invention.

FIG. 3 is a flow chart illustrating the processing steps performed by the system of FIG. 1 in accordance with one embodiment of the present invention.

FIG. 4 illustrates an exemplary e-service data sheet in accordance with one embodiment of the present invention.

FIG. 5 illustrates a system according to a second embodiment of the present invention in which the publication and discovery mechanisms of the present invention can be implemented.

FIG. 6 illustrates a system according to a third embodiment of the present invention in which the publication and discovery mechanisms of the present invention can be implemented.

### DETAILED DESCRIPTION

An e-service publication and discovery method and system are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

System 100

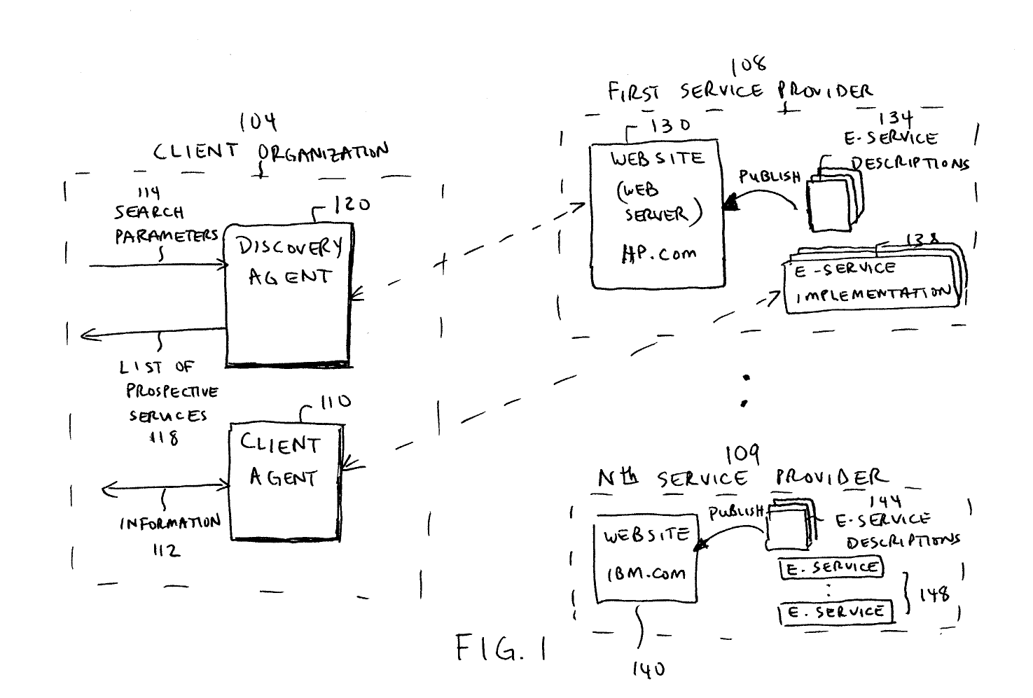

FIG. 1 illustrates a system 100 according to one embodiment of the present invention in which the publication and discovery mechanisms of the present invention can be implemented. The system 100 employs novel mechanisms of the present invention that enable businesses to 1) discover each other, 2) make their needs and capabilities known, and 3) integrate services using each businesses' preferred technology, Web services, and commerce processes.

The publication and discovery mechanisms of the present invention enable businesses to (1) discover each other, (2) define how they interact over the Internet, and (3) share information in a convenient and efficient manner. The publication and discovery mechanisms of the present invention also enable businesses to quickly, easily and dynamically find and transact with one another through their preferred applications.

The system 100 can include a client organization 104 and a plurality of service provider organizations 108. It is noted that the client organization 104 can be, but is not limited, to an individual, an organization (e.g., a business), or other entity that is in need for e-services. The individual can be, for example, a user, a consumer, a buyer, purchaser, etc. The other entity can include, but is not limited to, a software client, other processing program, or an electronic device (e.g., a web appliance, handheld PC, cellular telephone, or portable computer).

A first service provider 108 includes a web server 130 that maintains a web site for the first service provider 108 (e.g., www.hp.com). A first service provider 108 also includes one or more e-service descriptions 134, where each description corresponds to an e-service implementation 138.

An Nth service provider 109 includes a web server 140 that maintains a web site for the Nth service provider (e.g., www.ibm.com). The Nth service provider 109 also includes one or more e-service descriptions 144, where each description corresponds to an e-service implementation 148.

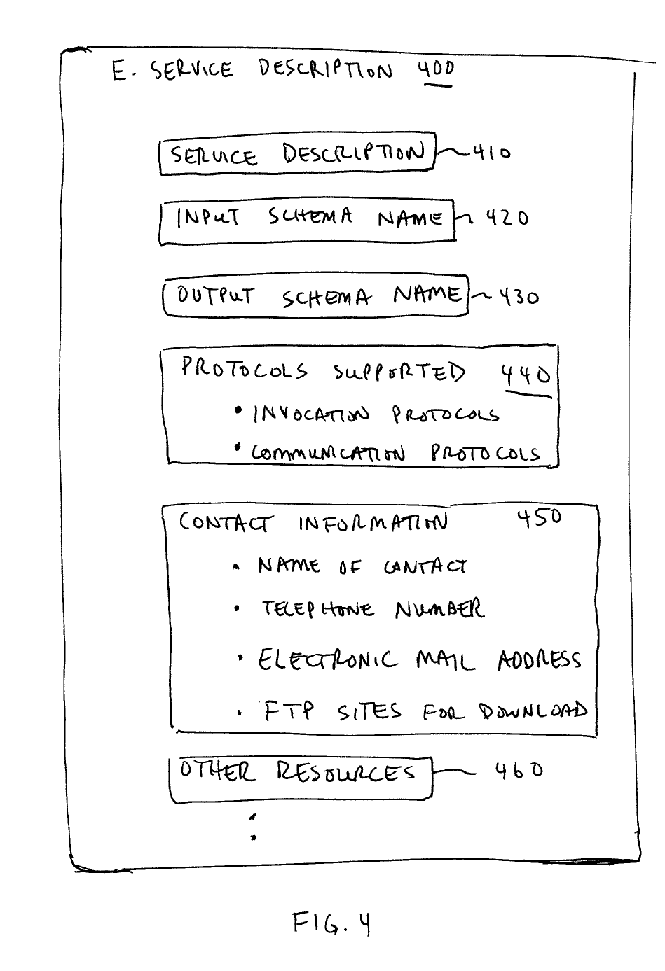

The service provider organizations publish information (e.g., an e-service description or data sheet) concerning services in a predetermined format and preferably in a particular location. The predetermined format is preferably an e-service data sheet, which is described in greater detail hereinafter with reference to FIG. 4 and TABLE I. It is noted that the service provider organizations 108 can be, but is not limited, to an individual, an organization (e.g., a business), or other entity that provides one or more e-services. The entity can be, for example, but is not limited to, a software program or other electronic computing device.

The particular location can be, for example, a web site of a company. For example, the particular location for Hewlett Packard, the assignee of the present application, can be its web site 130 (i.e., www.hp.com). For example, the particular location for IBM can be its web site 140 (i.e., www.ibm.com). It is noted that the particular location can be any widely known location that is accessible by clients.

The client organization 104 employs a discovery agent 120 to obtain a list of prospective e-services that meet user-defined search parameters. The client organization 104 provides to the discovery agent 120 one or more search parameters 114.

The search criteria 114 can include, for example, traits or characteristics of the requested services. The traits or characteristics can include, but is not limited to, keywords, function of the services, description of the services, input data parameters, and output data parameters. The search criteria 114 can also include a logical expression that has two or more traits or characteristics and a logical operation that has the traits or characteristics as operands. These logical operations can include simple operations (e.g., an AND operation, an OR operation, a NOT operation, greater than, less than, and equal to) or more complicated logical operations (e.g., an XOR operation). For example, a search parameter may specify “Price<$25.00 AND Quantity>1000 units.”

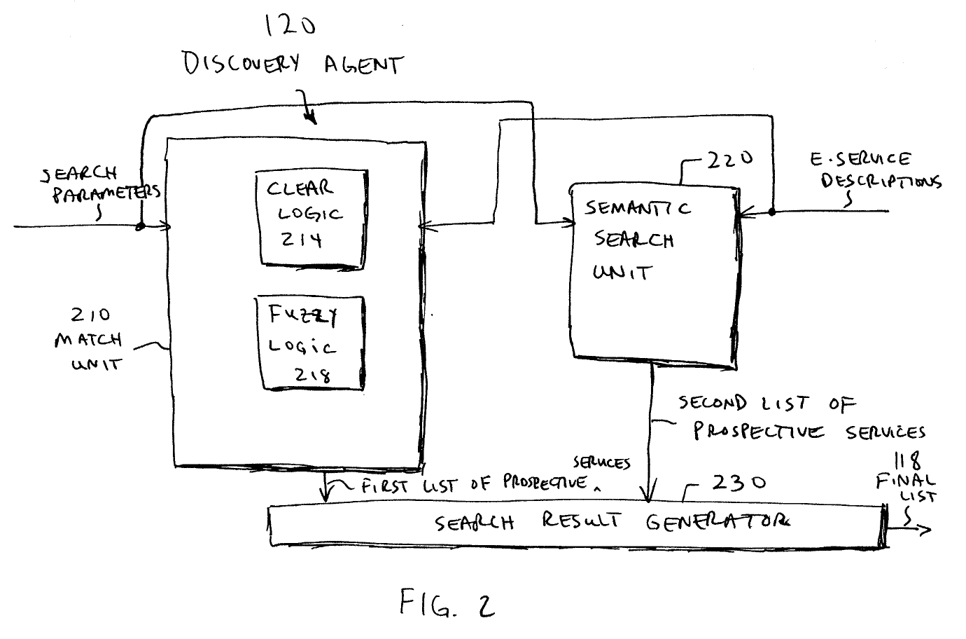

The discovery agent 120 searches the predetermined locations (e.g., the World Wide Web) for those services that meet the search parameters 114 and returns a list of prospective services 118 to the client organization 104. For example, the discovery agent 120 can compare portions of the search criteria to selected fields in the published e-service data sheets (e.g., data sheet 134 and 144). The discovery agent 120 is described in greater detail hereinafter with reference to FIG. 2.

Once discovered, the client organization can utilize the client agent 110 to connect and otherwise communicate with the service provider (e.g., the first service provider, the second service provider, . . . Nth service provider) or with an e-service implementation 138.

Discovery Agent 120

FIG. 2 is a block diagram illustrating in greater detail the discovery agent 120 of FIG. 1 according to one embodiment of the present invention. The discovery agent 120 includes a match unit 210, a semantic search unit 220, and a search result generator 230. The match unit 210 includes an input for receiving the search criteria 114 and an input for receiving the data sheets for published e-services. Based on these inputs, the match unit 210 generates candidate search results (e.g., a first list of prospective services).

In one embodiment, the match unit 210 employs “clean” logic 214 that determines with certainty whether a particular e-service is present or available at the web site. In an alternative embodiment, the match unit 210 utilizes “fuzzy” logic 218 that determines a probability of whether a particular e-service is available at a particular web site. For example, a fuzzy logic match unit 210 that provides a high probability (e.g., 90%) that a particular search term or terms may be found at a particular web site indicates that that there is a likely match at the web site. However, a low probability (e.g., 30%) that a particular search term or terms may be found at a particular web site indicates that there is probably no match at the web site.

In yet another embodiment, the match unit 210 employs clean logic 214 in certain cases, fuzzy logic 218 in other cases, and may employ a combination of clean and fuzzy logic of yet other cases. For example, the match unit 210 can allow a user (e.g., the client organization) to select whether “clean” logic 214 is utilized or whether “fuzzy” logic is employed.

The semantic search unit 220 includes an input for receiving the search criteria 114 and an input for receiving the data sheets for published e-services. Based on these inputs, the semantic search unit 220 generates candidate search results (e.g., a second list of prospective services). The semantic search unit 220 can, for example, focus on

The search result generator 230 includes an input for receiving the candidate search results from the match unit 210 and an input for receiving the candidate search results from the semantic search unit 220.

Based on these inputs, the search result generator 230 generates a final list 118 of e-services that meets the provided search criteria 114. The search result generator 230 can, for example, present a list that includes the all the search results from the match unit 210 and the semantic search unit 220. Alternatively, the search result generator 230 can present only those search results that meet a predetermined criterion. For example, only those results from a match unit 210 that employs fuzzy logic that have a probability higher than 80% are presented. Preferably, the list of e-services that is generated meets a first predetermined standard for the match unit 210 and a second predetermined standard for the semantic search unit 220. In this manner, there is a greater likelihood that the list of e-services will contain an e-service for which the client organization 104 is searching.

In one embodiment, the client organization 104 can search for e-services by category (e.g., consulting services). The discovery agent then returns a list of all service providers who offer consulting services.

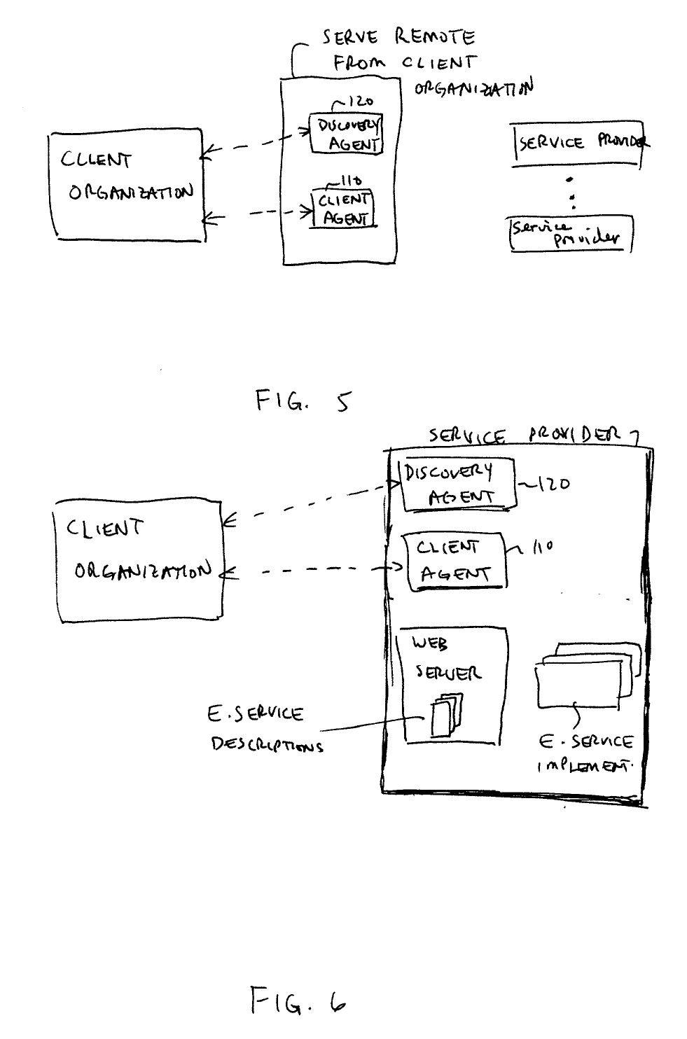

FIG. 5 illustrates a system according to a second embodiment of the present invention in which the publication and discovery mechanisms of the present invention can be implemented. In this embodiment, the discovery agent and the client agent are disposed in a location that is remote from the client organization. For example, the discovery agent and the client agent can reside on a remote server or other computing device. As long as the client organization has the address of the server, the client organization can access (e.g., download and execute) the discovery agent and the client agent when the client organization wants to conduct a search for e-services or otherwise interact with the service provider.

FIG. 6 illustrates a system according to a third embodiment of the present invention in which the publication and discovery mechanisms of the present invention can be implemented. In this embodiment, the discovery agent and the client agent are disposed at one of the service providers. In this example, the client organization can download the discovery agent and the client agent from the service provider and then perform e-service discovery.

Service Publication and Discovery Processing

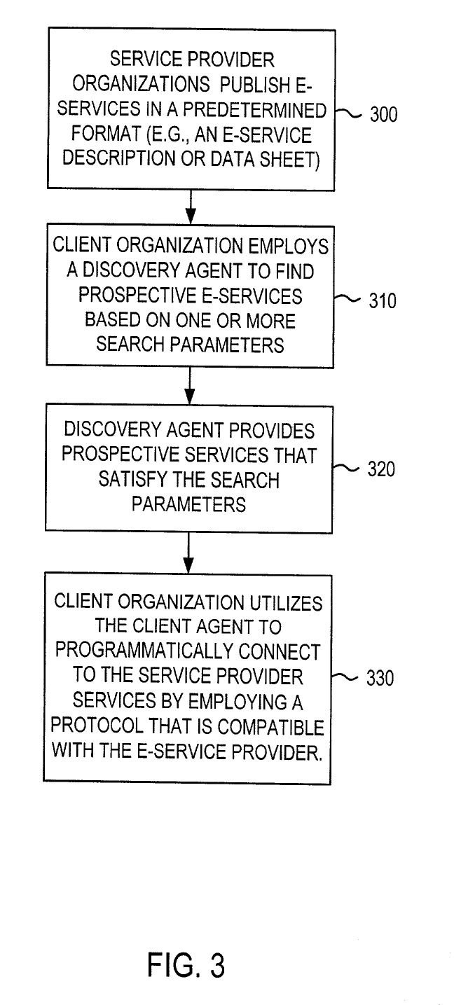

FIG. 3 is a flow chart illustrating the processing steps performed by the system of FIG. 1 in accordance with one embodiment of the present invention. In step 300, service provider organizations 108 publish e-service descriptions in a predetermined format, such as an e-service data sheet, an example of which is described in greater detail hereinafter with reference to FIG. 4. The e-services are also published in a predetermined location (e.g., the web site of the service provider organization).

In step 310, the client organization employs a discovery agent to find prospective e-services based on one or more search parameters. For example, the client organization provides one or more search parameters 114 (e.g., a search criteria expressed with Boolean operators) to the discovery agent 120. The search parameters 114 can be, for example, a brief description of the service by keywords, by category, or by logical forms and expressions.

In step 320, the discovery agent 120 provides prospective services that satisfy the search parameters 114.

In step 330, the client organization 104 employs a client agent 110 to programmatically connect to the e-service by employing a protocol that is compatible with the e-service provider. For example, the client agent 110 can employ a communication protocol and invocation protocol that is compatible with the service provider organization. The protocols can be, for example, specified in the e-services data sheet.

E-service Data Sheet

FIG. 4 illustrates an exemplary e-service data sheet 400 in accordance with one embodiment of the present invention. The e-service data sheet 400 can include a service description 410, an input schema name 420, an output schema name 430, and a field 440 for specifying the protocols (e.g., invocation and communication protocols) supported. The service description field 410 can be searched by the discovery agent 120 to find the search parameters. The input schema name 420 is utilized for identifying the particular input schema used by the data sheet. The output schema name 430 is utilized for identifying the particular output schema used by the data sheet. The field 440 for specifying the invocation protocols can specify, for example, one or more of the following protocols illustrated in TABLE I.

TABLE I

HyperText Transfer Protocol (HTTP)
File Transfer Protocol (FTP)
Microsoft Message Queue Server (MSMQ)
Others

The e-service description 400 can also include contact information 450 (e.g., a name of a contact, a telephone number for the contact, an electronic mail address for the contact, and ftp sites for downloading further information). The e-service description 400 can also include other resources 460 related to the e-service being offered.

Consider the case of a buyer who manufactures office machines (e.g., printers). The buyer is interested in purchasing a particular product or part that the buyer uses to build, assemble or manufacture printers. The search parameters can include, for example, the quantity of the product, the part number for the product, a list of preferred manufacturers of the product, and a price or price range for the product. The buyer can submit the following exemplary search parameters:

Quantity: 500

Part Description: Paper Roller Motor

Part Number: M-1423

Manufacturer: Canon & HP

Price: $30.00

It is noted that the search parameters may be entered in a predetermined form that lists various field that may be filled in by a user or left blank. The search is then an AND operation of all field that are specified with a value or other text string.

The discovery agent returns a list of possible service providers that can supply the above part subject to the parameters provided above. The discovery agent can also provide the e-service data sheets for the particular e-service. As noted previously, the e-service data sheets can include contact information (e.g., an electronic mail address, or a contact telephone number, and contact person) for use by the buyer for further inquiries, orders, etc.

Preferably, the e-service data sheet (e.g., data sheet 134 or 144) is in the form of a mark-up language document (e.g., an XML document). In this manner, each search parameter may be identified with a tag. These tags can be identified so that the document is easier to interpret and parse. Consequently, such a data sheet is relatively easy to search since the tags may be employed during the search process.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for publication and discovery of e-services in a system having a client organization, a discovery agent, a client agent, and one or more service provider organizations that provide e-services, the method comprising the steps of:
a) the service provider organizations publishing at least one e-service description in a predetermined format;
b) the client organization employing a discovery agent to find prospective e-services based on one or more search parameters;
c) the discovery agent providing prospective services that satisfy the search parameters; and
d) the client organization utilizing the client agent to programmatically connect to one or more prospective services by employing a protocol that is compatible with the service provider organizations.

2. The method of claim 1 wherein the e-services are published in a predetermined location.

3. The method of claim 2 wherein the predetermined location is the website of the service provider organization.

4. The method of claim 1 wherein the search parameters includes a description of the service by one of keywords, category, logical forms and expressions.

5. The method of claim 1 wherein the protocol includes a communication protocol and an invocation protocol.

6. The method of claim 1 wherein the protocol includes one of HyperText Transfer Protocol (HTTP), File Transfer Protocol (FTP), and Microsoft Message Queue Server (MSMQ).

7. The method of claim 1 wherein the predetermined format includes an e-service data sheet.

8. The method of claim 1 wherein the e-service description is a mark-up language document.

9. The method of claim 1 wherein the e-service description is an XML document.

10. The method of claim 7 wherein the e-service description includes one of a service description, input schema name, output schema name, and protocols-supported field.

11. A system for comprising:
a) a client organization that provides at least one search parameter for an electronic service;
b) at least one service provider organization for publishing an e-service description in a predetermined format; and
c) a discovery agent for use by the client organization; wherein the discovery agent receives the search parameter and provides at least one e-service that matches the search parameter.

12. The system of claim 11 wherein the discovery agent and the client agent are disposed in the client organization.

13. The system of claim 11 wherein the discovery agent and the client agent are disposed in one of the service provider organizations.

14. The system of claim 11 wherein the discovery agent and the client agent are disposed in a location that is remote from the client organization.

15. The system of claim 11 wherein the discovery agent includes
a match unit for receiving one or more search parameters and one or more e-service descriptions, and based thereon for generating a first list of prospective services that meet the search parameters;
a semantic search unit for receiving one or more search parameters and one or more e-service descriptions, and based thereon for generating a second list of prospective services that meet the search parameters; and
a search result generator coupled to the match unit and semantic search unit for receiving the first list of prospective services and the second list of prospective services and based thereon for generating a final list of prospective services.

16. The system of claim 15 wherein the match unit includes one of clean logic, fuzzy logic, and a combination thereof.

17. The system of claim 15 wherein the search parameters includes a description of the service by one of keywords, category, logical forms and expressions.

18. The system of claim 11 wherein the e-service description is a mark-up language document.

19. The system of claim 18 wherein the e-service description is an XML document.

20. The system of claim 11 wherein the e-service description includes one of a service description, input schema name, output schema name, and protocols-supported field.
